(19) United States
(12) Patent Application Publication
(10) Pub. No.: US 2020/0301139 A1
(43) Pub. Date: Sep. 24, 2020

(54) HEAD-UP DISPLAY SYSTEM

(71) Applicant: Visteon Global Technologies, Inc., Van Buren Township, MI (US)

(72) Inventors: Chao-Hung Lin, Canton, MI (US); Sebastien Hervy, Trie-Chateau (FR); Paul Fredrick Luther Weindorf, Novi, MI (US); Elie Abi-Chaaya, Jouy le Moutier (FR); Thierry Dommanget, Auteuil-Le-Roi (FR)

(73) Assignee: Visteon Global Technologies, Inc., Van Buren Township, MI (US)

(21) Appl. No.: 16/824,815

(22) Filed: Mar. 20, 2020

Related U.S. Application Data
(60) Provisional application No. 62/822,464, filed on Mar. 22, 2019.
(60) Provisional application No. 62/836,311, filed on Apr. 19, 2019.

(51) Int. Cl. G02B 27/01; G02F 1/1335; G09G 3/36

(52) U.S. Cl. CPC G02B 27/0101; G09G 3/3648; G02F 1/133528

(57) ABSTRACT

A head-up display system includes a display device, a liquid crystal cell and a driver circuit. The display device is configured to generate multiple images at a frame rate. Each image includes multiple image segments with an initial polarization. The liquid crystal cell includes multiple addressable segments. The addressable segments are aligned with the image segments. The addressable segments are individually controllable to selectively adjust the initial polarization of the image segments between two different polarizations. The driver circuit is in communication with the display device and the liquid crystal cell. The driver circuit is configured to control the addressable segments to pass each image segment that has visible content to a user with the initial polarization switched between the two different polarizations at a frequency greater than the frame rate of the images and attenuate sunlight incident on the display device at each image segment that has blank content.

### CROSS-REFERENCE TO RELATED APPLICATIONS

This application claims the benefit of U.S. Provisional Application No. 62/822,464, filed Mar. 22, 2019, and U.S. Provisional Application No. 62/836,311, filed Apr. 19, 2019, each of which are hereby incorporated by reference in their entirety.

### TECHNICAL FIELD

Various display systems may benefit from a suitable implementation of polarization. For example, a fast polarization switching apparatus can provide a polarized head-up display picture generation unit with vertical polarization and horizontal polarization output in a frame.

### BACKGROUND

In a head-up display, a display mechanism can generate an image that is projected onto a screen, such as a windshield of a car. The display mechanism can have an adjustable brightness mechanism. The display mechanism can include a polarization system. For example, a fixed half-wave plate (HWP) or quarter-wave plate (QWP) can be used to provide the polarization. These approaches can introduce color shifts, produce visible interference flicker and are vulnerable to solar-induced internal heating.

### SUMMARY

This section provides a general summary of the disclosure and is not a comprehensive disclosure of its full scope or all of its features, aspects or objectives.

A head-up display system is provided herein. The head-up display system includes a display device, a liquid crystal cell and a driver circuit. The display device is configured to generate a plurality of images at a frame rate. Each of the plurality of images includes a plurality of image segments with an initial polarization. The liquid crystal cell is disposed between the display device and a user of the head-up display system. The liquid crystal cell includes a plurality of addressable segments that are aligned with the plurality of image segments. The plurality of addressable segments are individually controllable to selectively adjust the initial polarization of the plurality of image segments between two different polarizations.

The driver circuit is in communication with the display device and the liquid crystal cell. The driver circuit is configured to control the plurality of addressable segments to pass each of the plurality of image segments that has visible content to the user with the initial polarization switched between the two different polarizations at a frequency greater than the frame rate of the plurality of images and attenuate sunlight that is incident on the display device at each of the plurality of image segments that has blank content.

A head-up display system is provided herein. The head-up display system includes a display device, a liquid crystal cell and a driver circuit. The display device is configured to generate a plurality of images at a frame rate and with an initial polarization. The liquid crystal cell is disposed between the display device and a user of the head-up display system. The liquid crystal cell is controllable to selectively adjust the initial polarization of the plurality of images between two different polarizations.

The driver circuit is in communication with the display device and the liquid crystal cell. The driver circuit is configured to control the liquid crystal cell to pass the plurality of images to the user with the initial polarization switched between the two different polarizations at a frequency greater than the frame rate of the plurality of images.

A head-up display system is provided herein. The head-up display system includes a display device, a liquid crystal cell and a driver circuit. The display device is configured to generate a plurality of images. Each of the plurality of images includes a plurality of image segments with an initial polarization. The liquid crystal cell is disposed between the display device and a user of the head-up display system. The liquid crystal cell includes a plurality of addressable segments that are aligned with the plurality of image segments. The plurality of addressable segments are individually controllable to selectively adjust the initial polarization of the plurality of image segments between two different polarizations.

The driver circuit is in communication with the display device and the liquid crystal cell. The driver circuit is configured to control the plurality of addressable segments to pass each of the plurality of image segments that has visible content to the user and attenuate sunlight that is incident on the display device at each of the plurality of image segments that has blank content.

In one or more embodiments of the head-up display system, the liquid crystal cell includes a reflective polarizer configured to reflect the sunlight that has one of the two different polarizations.

The above features and advantages and other features and advantages of the present teachings are readily apparent from the following detailed description of the best modes for carrying out the teachings when taken in connection with the accompanying drawings.

### BRIEF DESCRIPTION OF THE DRAWINGS

FIG. 1 illustrates a schematic diagram of a vehicle having a head-up display system in accordance with one or more embodiments.

FIG. 2 illustrates a schematic diagram of a screen in accordance with one or more embodiments of the head-up display system.

FIG. 3 illustrates a schematic block diagram of a picture generation unit in accordance with one or more embodiments of the head-up display system.

FIG. 4 illustrates a flow diagram of a method of operation in accordance with one or more embodiments of the head-up display system.

FIG. 5 illustrates a graph of waveforms for a normal mode in accordance with one or more embodiments of the head-up display system.

FIG. 6 illustrates a graph of waveforms for a polarized sunglasses mode in accordance with one or more embodiments of the head-up display system.

FIG. 7 illustrates a schematic diagram of a segmented twisted nematic cell in accordance with one or more embodiments of the head-up display system.

FIG. 8 illustrates a schematic diagram of a picture generation unit in a non-rotation state in accordance with one or more embodiments of the head-up display system.

FIG. 9 illustrates a schematic diagram of the picture generation unit in a mixed-rotation state in accordance with one or more embodiments of the head-up display system.

FIG. 10 illustrates a schematic diagram of another picture generation unit in the rotation state in accordance with one or more embodiments of the head-up display system.

FIG. 11 illustrates a schematic diagram of the other picture generation unit in the mixed-rotation state in accordance with one or more embodiments of the head-up display system.

FIG. 12 illustrates a schematic block diagram of a driver circuit and a liquid crystal cell in accordance with one or more embodiments of the head-up display system.

### DETAILED DESCRIPTION

Those having ordinary skill in the art will recognize that terms such as “above,” “below,” “front,” “back,” “upward,” “downward,” “top,” “bottom,” etc., may be used descriptively herein without representing limitations on the scope of the disclosure. Furthermore, the present teachings may be described in terms of functional and/or logical block components and/or various processing steps. Such block components may be comprised of various hardware components, software components executing on hardware, and/or firmware components executing on hardware.

Embodiments of the disclosure may have various modifications and alternative forms, and some representative embodiments are shown by way of example in the drawings and will be described in detail herein. Novel aspects are not limited to the particular forms illustrated in the above-enumerated drawings. Rather, the disclosure is to cover modifications, equivalents, and combinations falling within the scope of the disclosure.

Certain embodiments generally relate to a head-up display system mountable in a motor vehicle. The head-up display system may be, for example, a fast polarization switching apparatus that provides polarized head-up display images (or pictures) with both vertical polarization and horizontal polarization. A frequency that the head-up display system switches between the vertical polarization and the horizontal polarization may be a higher frequency than the frame rate of the images being projected to a user (e.g., an occupant or a driver of the vehicle) to avoid an interference flicker perceptible to the user.

In various embodiments, the head-up display system may include an individually addressable segmented liquid crystal cell (or layer). The addressable segments may be independently controlled to rotate light or reflect light. In particular, some segments may be controlled to transmit portions of images generated by a display that contain visual content for the user. Other segments may be controlled to reflect sunlight entering the head-up display system from outside the vehicle. By reflecting some of the sunlight, a display device within the head-up display system may operate with a lower thermal load from the sun.

The human visual system generally experiences persistence of vision. More particularly, the human brain feels an illusion from a period of visual perception. In that period, the head-up display system may provide a vertical polarization state for a portion of the period and provide a horizontal polarization state in the other portion of the period. When the user is not wearing polarized sunglasses, the brain perceives intermediate brightness level from both the vertical polarization state brightness and the horizontal state brightness. When the user is wearing the polarized sunglasses, the brain perceives brightness mainly from the vertical polarization state brightness. The head-up display system may change the duty cycle of the vertical polarization state relative to the horizontal polarization state to better optimize the brightness for either a normal usage user or a polarized sunglasses wearing user.

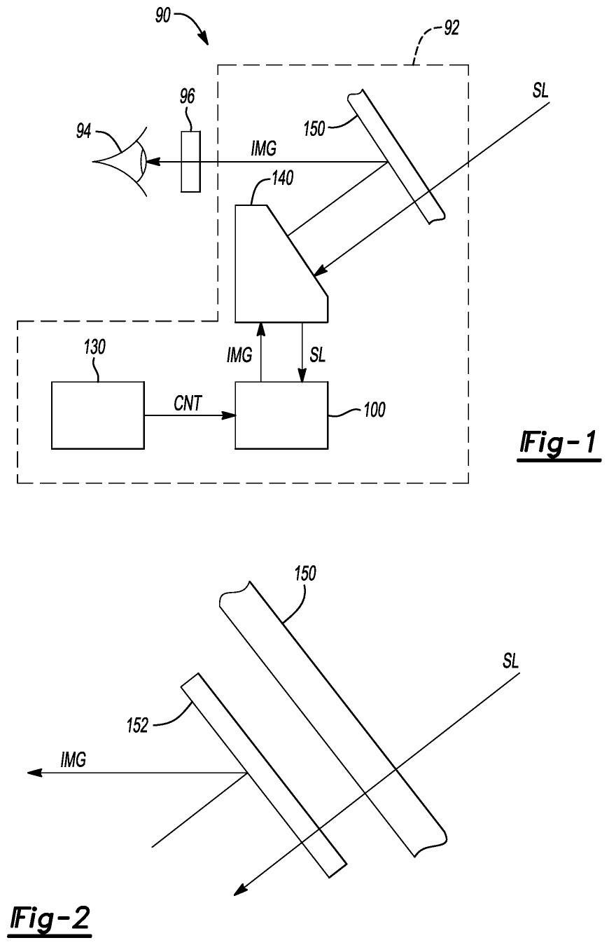

FIG. 1 illustrates a schematic diagram of an example implementation of a vehicle 90 in accordance with one or more embodiments. The vehicle 90 generally comprises a head-up display system 92 positioned before the user 94. The user 94 may optionally be wearing polarized sunglasses 96. In various embodiments, the vehicle 90 may include a windshield 150. The head-up display system 92 may comprise a picture generation unit 100, a driver circuit 130, an optical setup 140 and the windshield 150.

A control signal (e.g., CNT) may be generated by the driver circuit 130 and transferred to the picture generation unit 100. The control signal CNT may convey control information used to control the operations of the picture generate unit 100. An optical signal (e.g., IMG) may be generated by the picture generation unit 100 and transferred to the user 94 through the optical setup 140, reflected off the windshield 150, pass through the polarized sunglasses 96 and seen by the user 94. The optical signal IMG may carry a sequence of images at a frame rate. Another optical signal (e.g., SL) may be received by the head-up display system 92 from outside the vehicle 90. The signal SL may be sunlight streaming into the optical setup 140 through the windshield 150. The optical setup 140 may direct the sunlight SL to the picture generation unit 100. The sunlight SL generally has multiple polarized states (e.g., a vertical polarized state and a horizontal polarized state). The terms vertical polarization and the horizontal polarization may be determined relative to the ground on which the vehicle 90 is situated.

The vehicle 90 may include mobile vehicles such as automobiles, trucks, motorcycles, boats, trains and/or aircraft. The vehicle 90 may receive the sunlight SL from the sun through at least the windshield 150.

The head-up display system 92 may be implemented as a windshield head-up display or a screen head-up display. The head-up display system 92 is generally operational to generate and present visual information in the optical signal IMG to the user 94. The visual information may include various data regarding the operation of the vehicle 90 in the forms of graphics, texts, and the like. The head-up display system 92 may receive a portion of the sunlight SL while the sunlight SL is entering the windshield 150.

The polarized sunglasses 96 may be employed by the user 94 in some situations. For example, the user 94 may wear the polarized sunglasses 96 on bright sunny days. The polarized sunglasses are generally operational to pass light (e.g., the optical signal IMG and the sunlight SL) having the vertical polarization. Light having non-vertical polarization may be attenuated by the polarized sunglasses 96 while the eyes of the user 94 are oriented horizontally relative to each other.

The picture generation unit 100 may implement a projection device. The picture generation unit 100 is generally operational to generate and present the optical signal IMG in response to the control information received in the control signal CNT. The picture generation unit 100 may be aligned with the optical setup 140 to transfer the optical signal IMG. The sunlight SL received by the picture generation unit 100 generally causes localized heating within the picture generation unit 100. To help reduce the heating, the picture generation unit 100 may be operable in one or more modes to partially reflect the sunlight SL where and whenever possible.

The driver circuit 130 may implement one or more microcontrollers. The driver circuit 130 is generally operational to control the picture generation unit 100 to create the optical signal IMG. The driver circuit 130 may be configured to alter a duty cycle of the picture generation unit 100 based on an active mode (e.g., a polarized sunglasses mode or a normal mode) in the head-up display system 92.

Each microcontroller may include one or more processors, each of which may be embodied as a separate processor, an application specific integrated circuit (ASIC), a field programmable gate array (FPGA), or a dedicated electronic control unit.

The microcontrollers may be any sort of electronic processors (implemented in hardware, software executing on hardware, or a combination of both). The microcontrollers may also include tangible, non-transitory memory, (e.g., read only memory in the form of optical, magnetic, and/or flash memory). For example, a microcontroller may include application-suitable amounts of random-access memory, read-only memory, flash memory and other types of electrically-erasable programmable read-only memory, as well as accompanying hardware in the form of a high-speed clock or timer, analog-to-digital and digital-to-analog circuitry, and input/output circuitry and devices, as well as appropriate signal conditioning and buffer circuitry.

Computer-readable and executable instructions embodying the present disclosure may be stored in the memory and executed as set forth herein. The executable instructions may be a series of instructions employed to run applications on the microcontrollers (either in the foreground or background). The microcontrollers may receive commands and information, in the form of one or more input signals from various controls or components in the vehicle 90 and communicate the commands to the picture generation unit 100 through the control signal CNT.

The optical setup 140 may implement one or more mirrors and/or lenses that direct the optical signal IMG onto the windshield 150. The mirrors may be curved to adjust a focal point of the images.

The windshield 150 implement an automotive windshield. The windshield 150 may be operational to reflect the images received from the optical setup 140 toward the user 94. The windshield 150 is transparent and so allows the sunlight SL to enter an interior of the vehicle 90. Because of an inclination of the windshield 150, the vertical component (or P-component) of the sunlight energy may be larger than the horizontal component (or S-component), in a ratio of approximately 1.75:1.

FIG. 2 illustrates a schematic diagram of an example implementation of a screen 152 in accordance with one or more embodiments of the head-up display system 92. In some embodiments of the head-up system 92, the screen 152 may be disposed between the optical setup 140 and the windshield 150. The screen 152 may provide an optical surface from which the optical signal IMG is reflected toward the user 94. Since the screen 152 is generally transparent for the sake of the user's forward field of view, the screen 152 also allows the sunlight SL to enter the optical setup 140.

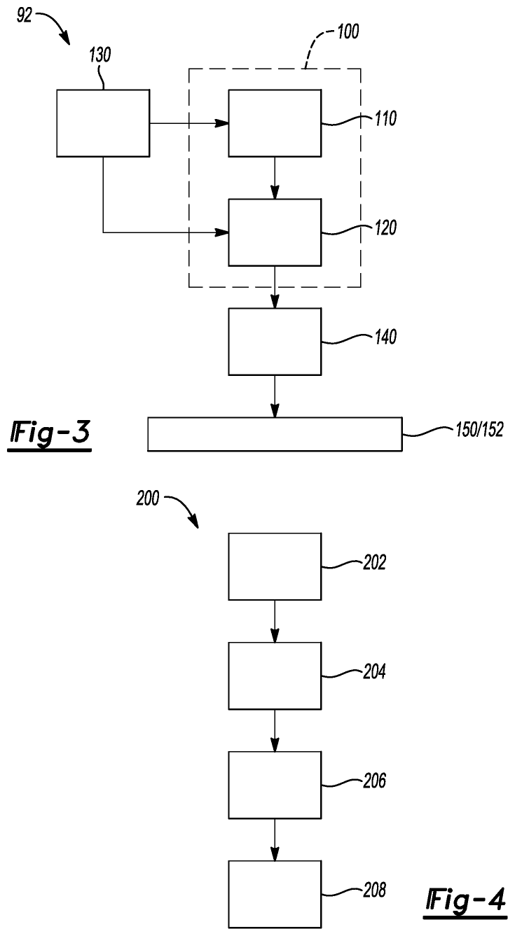

FIG. 3 illustrates a schematic block diagram of an example implementation of the picture generation unit 100 in accordance with one or more embodiments of the head-up display system 92. The picture generation unit 100 generally comprises a display device 110 and a liquid crystal cell 120. The display device 110 and the liquid crystal cell 120 may be in electrical communication with the driver circuit 130. The optical signal IMG may be projected by the display device 110, through the liquid crystal cell 120, through the optical setup 140 to the windshield 150 or the screen 152.

The display device 110 may implement an active display. The display device 110 is generally operational to generate and present a sequence of images in the optical signal IMG. The images may be generated at a frame rate controllable by the driver circuit 130. The images may also have an initial polarization (e.g., an S-polarization or a P-polarization). In various embodiments, the display device 110 may be implemented as a thin-film transistor display device with a built-in backlight. In some embodiments, the display device 110 may be implemented as a liquid crystal display device with a built-in backlight. Other display types, including, but not limited to, organic light emitting diode displays may also be implemented to meet the design criteria of a particular application.

The liquid crystal cell 120 may implement an active polarization modulator. The liquid crystal cell 120 is generally operational to rotate the initial polarization of the images in the optical signal IMG in response to a control voltage in the control signal CNT. In various embodiments, the liquid crystal cell 120 may be a twisted nematic liquid crystal cell. In other embodiments, the liquid crystal cell 120 may be a Pi-cell, a vertical alignment liquid crystal cell, or a ferroelectric liquid crystal cell. Other types of active polarization modulators may be implemented to meet the design criteria of a particular application.

The control voltage carried by the control signal CNT that corresponds to the liquid crystal cell 120 may be generated over a range of voltages (e.g., zero volts to 5 volts). The liquid crystal cell 120 may respond to the zero volts by passing the optical signal IMG without a rotation of the initial polarization. The liquid crystal cell 120 may respond to the 5 volts by rotating the initial polarization of the optical signal IMG by approximately 90 degrees. To achieve a rotation between zero degrees and 90 degrees, either an intermediate voltage may be applied to the liquid crystal cell 120 and/or the applied control voltage may be modulated between zero volts and 5 volts. For example, applying a 2.5 volt control signal may result in an approximately 45 degree rotation of the optical signal IMG. In another example, modulating the applied control voltage with a duty cycle of 50% at zero volts and 50% at 5 volts may be perceived by the user 94 as a 45 degree rotation of the polarization.

FIG. 4 illustrates a flow diagram of an example method 200 of operation in accordance with one or more embodiments of the head-up display system 92. The operational method (or process) 200 may be implemented by the components of the head-up display system 92. The operational method 200 generally comprises a step 202, a step 204, a step 206 and a step 208.

In the step 202, the display device 110 may be driven by the driver circuit 130 to create the optical signal IMG. The optical signal IMG may be generated at a frame rate established by the driver circuit 130. The driver circuit 130 may control the liquid crystal cell 120 in the step 204 to switch between the two different polarizations at a frequency greater than the frame rate of the images in the optical signal IMG. For example, one of the polarizations may be a non-rotated polarization where the liquid crystal cell 120 passes the images in the optical signal IMG without altering the initial polarization of the images. The other polarization may be a rotated polarization where the liquid crystal cell 120 rotates the initial polarization of the images by approximately 90 degrees as the images transit the cell.

The switching frequency between the two different polarizations may be controlled to avoid a generation of visible interference flickering (or beat frequency) in the images as seen by the user 94. In various embodiments, the switching frequency may be certain harmonics of the frame rate of the images. For example, the switching frequency may be twice that of the frame rate such that each image frame is transferred with the initial polarization for part of the frame period and with the rotated polarization for the remainder of the frame period. Various harmonic frequencies of the frame rate that would result in the flickering may be avoided. Other switching frequencies may be implemented to meet a design criteria of a particular application.

In the step 206, the optical signal IMG may be transferred through the optical setup 140 and directed toward the windshield 150 and/or the screen 152. The windshield 150 or the screen 152 may direct the optical signal IMG toward the user 94 in the step 208.

The switching of the liquid crystal cell 120 in each image frame generally results in the optical signal IMG reaching the user 94 in both the horizontal polarization state and the vertical polarization state at slightly different times. The temporal shift between the two polarization states may be imperceptibly short to the user 94. In a normal mode of operation of the head-up display system 92, a duration of the horizontal polarization state and a duration of the vertical polarization state of the optical signal IMG may be approximately the same (e.g., a first duty cycle). Activation of the normal mode may be suitable while the user 94 is not wearing the polarized sunglasses 96.

While the user 94 is wearing the polarized sunglasses 96, the horizontally polarized components of the images are attenuated by the polarized sunglasses 96. Therefore, the information being presented to the user 94 by the head-up display system 92 may appear dimmer than normal. To compensate for the presence of the polarized sunglasses 96, the head-up display system 92 may include a polarized sunglasses mode. While the polarized sunglasses mode is active, the driver circuit 130 may control the switching frequency of the liquid crystal cell 120 to emphasize the vertical polarization state more often than the horizontal polarization state (e.g., a second duty cycle). For example, the images adjusted by the liquid crystal cell 120 may be presented to the user 94 with the vertical polarization a majority of the period (e.g., 70% to 100%) and with the horizontal polarization during the rest of the period (e.g., 0% to 30%).

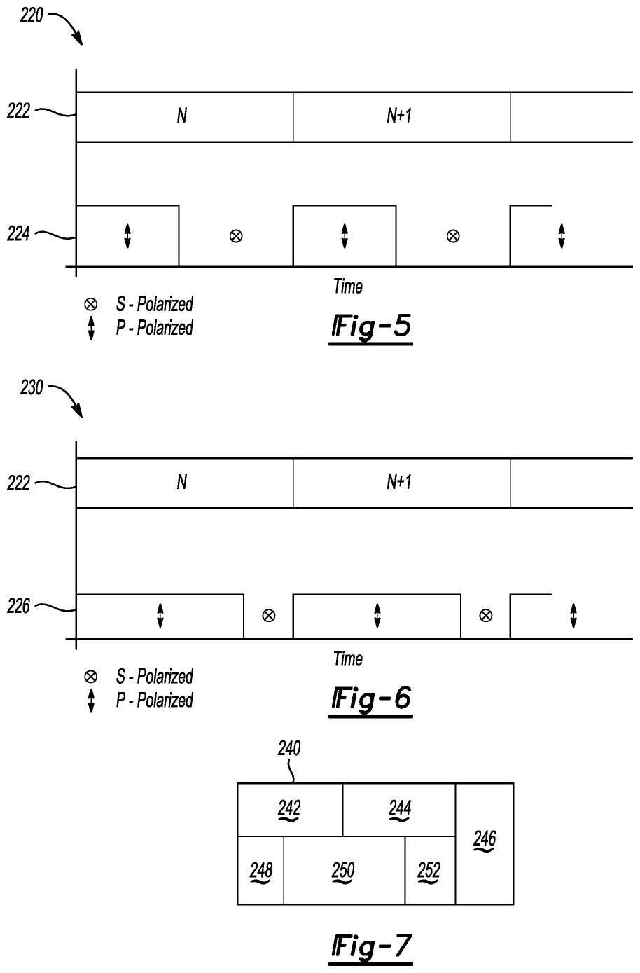

FIG. 5 illustrates a graph 220 of example waveforms for the normal mode in accordance with one or more embodiments of the head-up display system 92. The image frames may be illustrated by a waveform 222. Each image frame may persist for a single period. Successive image frames (e.g., N, N+1, etc.) may be temporally adjacent (or adjoining) each other. The liquid crystal cell 120 may be controlled per a waveform 224. During approximately a first half of each period, the liquid crystal cell 120 may be controlled to present the corresponding image such that the user 94 sees the vertical polarization. During approximately a second half of each period, the liquid crystal cell 120 may be controlled to present the corresponding image such that the user 94 sees the horizontal polarization.

FIG. 6 illustrates a graph 230 of example waveforms for the polarized sunglasses mode in accordance with one or more embodiments of the head-up display system 92. The image frames may be illustrated by the waveform 222. The liquid crystal cell 120 may be controlled per a waveform 226. During a majority of the first half of each period, the liquid crystal cell 120 may be controlled to present the corresponding image such that the user 94 sees the vertical polarization. During the minority remainder of each period, the liquid crystal cell 120 may be controlled to present the corresponding image such that the user 94 sees the horizontal polarization.

FIG. 7 illustrates a schematic diagram of an example implementation of a twisted nematic cell 240 in accordance with one or more embodiments of the head-up display system 92. The twisted nematic cell 240 may be used in the liquid crystal cell 120. In some embodiments, the twisted nematic cell 240 may comprise several addressable segments. The addressable segments may include a first addressable segment 242, a second addressable segment 244, a third addressable segment 246, a fourth addressable segment 248, a fifth addressable segment 250 and a sixth addressable segment 252. Other numbers and spatial arrangements of the addressable segments 242-252 may be implemented to meet a design criteria of a particular application.

Each addressable segment 242-252 may have a size and position within the twisted nematic cell 240 to align with information presented in corresponding image segments of the images. For example, the first addressable segment 242 may be aligned with a speedometer graphic image while the second addressable segment 244 may be aligned with a tachometer graphic image.

Each addressable segment 242-252 may be independently controlled by the control signal CNT to either the rotation state or the non-rotation state. The addressable segments 242-252 may respond to the zero volts by passing the corresponding image segment in the optical signal IMG without a rotation of the initial polarization. The addressable segments 242-252 may respond to the 5 volts by rotating the initial polarization of the corresponding image segment of the optical signal IMG by approximately 90 degrees. To achieve a rotation between zero degrees and 90 degrees, either an intermediate voltage may be applied to the addressable segments 242-252 and/or the applied voltage may be modulated between zero volts and 5 volts.

In some situations (e.g., the normal mode), the addressable segments 242-252 may be controlled together such that the user 94 sees entire images in the optical signal IMG with the horizontal polarization and the vertical polarization. In other situations (e.g., a cool mode), some of the addressable segments 242-252 may be held in just one of the rotation state or the non-rotation state. For example, while the image segments that corresponds to the addressable segment 246 and 248 do not contain any visible information, the addressable segments 246 and 248 may be controlled to cause the sunlight SL from reaching the display device 110. Keeping parts of the display device 110 shaded from the sunlight SL generally helps the display device 110 to remain cooler than if the sunlight SL were allowed through the addressable segments 246 and 248.

In the normal mode, the addressable segments 242-252 that have corresponding image segments with visible content may be switched between the rotation state and the non-rotation state at the first duty cycle (e.g., 50% V-50% H). Therefore, the user 94 not wearing the polarized sunglasses 96 may perceive the visible content in the vertical polarized state and the horizontal polarized state.

In the (first) polarized sunglasses mode, the addressable segments 242-252 that have corresponding image segments with visible content may be switched between the rotation state and the non-rotation state with the second duty cycle (e.g., 80% V-20% H). Therefore, the user 94 may perceive the visible content in predominantly the vertical polarized state (which easily passes through the polarized sunglasses 96).

In a second polarized sunglasses mode, the addressable segments 242-252 that have corresponding image segments with visible content may be controlled to one of the rotation state or the non-rotations state with a third duty cycle (e.g., 100% V-0% H). Therefore, the user 94 while wearing the polarized sunglasses 96 may perceive the visible content in solely the vertical polarized state.

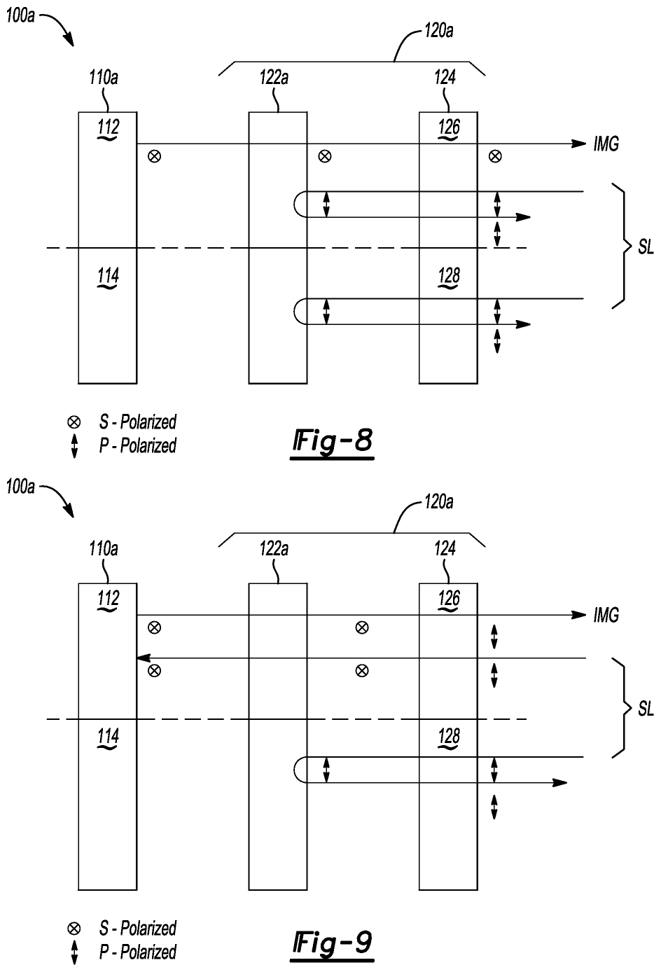

FIG. 8 illustrates a schematic diagram of an example implementation of a picture generation unit 100a in the non-rotation state in accordance with one or more embodiments of the head-up display system 92. The picture generation unit 100a generally comprises a display device 110a and a liquid crystal cell 120a. The liquid crystal cell 120a may comprise a reflective polarizer 122a and a twisted nematic cell 124. The picture generation unit 100a may be a variation of the picture generation unit 100. The display device 110a may be a variation of the display device 110. The twisted nematic cell 124 may be a variation of the twisted nematic cell 240.

The display device 110a may implement a display that generates the optical signal IMG with the S-polarization (or horizontal polarization). The display device 110a is generally controlled by the driver circuit 130 to present visible information arranged in predetermined positions and/or areas that define the multiple image segments. In the example, the display device 110a is illustrated with an “on” image segment 112 having visible content and an “off” image segment 114 having no visible content (e.g., no light emitted or blank). The image segment 112 may contribute to the optical signal IMG that is projected toward the reflective polarizer 122a.

The reflective polarizer 122a may be operational to pass S-polarized light (or horizontally polarized) and reflect P-polarized (or vertically polarized) light. In the example, the optical signal IMG generated by the “on” image segment 112 of the display device 100a may pass through the reflective polarizer 122a. The sunlight SL entering the picture generation unit 100a may be essentially P-polarized and so is reflected by the reflective polarizer 122a.

The twisted nematic cell 124 may have multiple addressable segments. The example illustrates addressable segments 126 and 128. The addressable segment 126 is aligned with the image segment 112. The addressable segment 128 is aligned with the image segment 114. While the addressable segments 126 and 128 are in an “on” state, the addressable segments 126 and 128 do not rotate the polarization of the optical signal IMG and the polarization of the sunlight SL. Therefore, the addressable segment 126 passes the visible content in the image segment 112 of the optical signal IMG unrotated to the optical setup 140. The addressable segments 126 and 128 pass the sunlight SL unrotated to the reflective polarizer 122a. The reflective polarizer 122a subsequently reflects the P-polarized sunlight SL back to the addressable segments 126 and 128. The addressable segments 126 and 128 again pass the P-polarized sunlight SL out of the picture generation unit 100a. Therefore, the P-polarized sunlight SL does not contribute to a heating of the display device 110a.

FIG. 9 illustrates a schematic diagram of an example implementation of the picture generation unit 100a in a mixed-rotation state in accordance with one or more embodiments of the head-up display system 92. The addressable segment 128 of the twisted nematic cell 124 may remain in the on (or non-rotation) state and the addressable segment 126 may be controlled to an off (or rotation) state.

The optical signal IMG may be generated by the image segment 112 of the display device 110a with the S-polarization. The S-polarized optical signal IMG may pass through the reflective polarizer 122a. While transiting through the “off” addressable segment 126, the S-polarization of the optical signal IMG may be rotated to P-polarization. Therefore, the user 94 receives the optical signal IMG with the P-polarization.

The P-polarized sunlight SL entering the “on” addressable segment 128 may continue through the twisted nematic cell 124 to the reflective polarizer 122a . The P-polarized sunlight SL may be reflected by the reflective polarizer 122a and back out of the head-up display system 92. The P-polarized sunlight SL entering the “off” addressable segment 126 may be rotated by the twisted nematic cell 124 to the S-polarization. Therefore, the S-polarized sunlight SL passes through the reflective polarizer 122a and may radiantly heat the display device 110a in the content area.

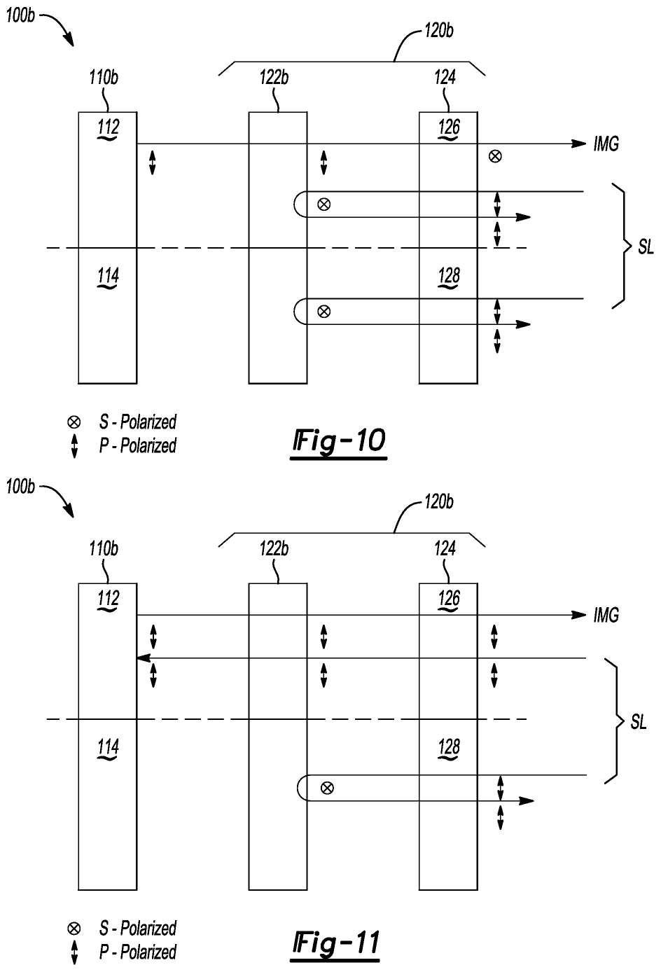

FIG. 10 illustrates a schematic diagram of an example implementation of a picture generation unit 100b in the rotation state in accordance with one or more embodiments of the head-up display system 92. The picture generation unit 100b generally comprises a display device 110b and a liquid crystal cell 120b. The liquid crystal cell 120b may comprise a reflective polarizer 122b and the twisted nematic cell 124. The picture generation unit 100b may be a variation of the picture generation unit 100. The display device 110b may be a variation of the display device 110. The twisted nematic cell 124 may be a variation of the twisted nematic cell 240.

The display device 110b may implement a display that generates the optical signal IMG with the P-polarization (or vertical polarization). The display device 110b is generally controlled by the driver circuit 130 to present visible information arranged in predetermined positions and/or areas that define the multiple image segments. In the example, the display device 110b is illustrated with the “on” image segment 112 having visible content and the “off” image segment 114 having no visible content (e.g., no light emitted or blank). The image segment 112 may contribute to the optical signal IMG that is projected toward the reflective polarizer 122b.

The reflective polarizer 122b may be operational to pass P-polarized (or vertically polarized) light and reflect S-polarized (or horizontally polarized) light. In the example, the optical signal IMG generated by the “on” image segment 112 of the display device 110b may pass through the reflective polarizer 122b. The sunlight SL entering the picture generation unit 100b may be essentially P-polarized, is rotated to the S-polarization by the twisted nematic cell 124 and so is reflected by the reflective polarizer 122a.

The twisted nematic cell 124 may have multiple addressable segments. The example illustrates addressable segments 126 and 128. The addressable segment 126 is aligned with the image segment 112. The addressable segment 128 is aligned with the image segment 114. While the addressable segments 126 and 128 are in the “off” state, the addressable segments 126 and 128 rotate the polarization of the optical signal IMG and the polarization of the sunlight SL. Therefore, the addressable segment 126 rotates the visible content in the image segment 112 of the optical signal IMG from the P-polarization to the S-polarization. The addressable segments 126 and 128 rotate the sunlight SL from the P-polarization to the S-polarization. The reflective polarizer 122b subsequently reflects the S-polarized sunlight SL back to the addressable segments 126 and 128. The addressable segments 126 and 128 rotate and pass the sunlight SL out of the picture generation unit 100a. Therefore, the P-polarized sunlight SL does not contribute to heating the display device 110b.

FIG. 11 illustrates a schematic diagram of an example implementation of the picture generation unit 100b in the mixed-rotation state in accordance with one or more embodiments of the head-up display system 92. The addressable segment 128 of the twisted nematic cell 124 may remain in the off (or rotation) state and the addressable segment 126 may be controlled to an on (or non-rotation) state.

The optical signal IMG may be generated by the image segment 112 of the display device 110b with the P-polarization. The P-polarized optical signal IMG may pass through the reflective polarizer 122b. While transiting through the “on” addressable segment 126, the P-polarization of the optical signal IMG may remain unrotated. Therefore, the user 94 receives the optical signal IMG with the P-polarization.

The P-polarized sunlight SL entering the “off” addressable segment 128 may be rotated by the twisted nematic cell 124 from the P-polarization to the S-polarization. The S-polarized sunlight SL may be reflected by the reflective polarizer 122b and back out of the head-up display system 92. The P-polarized sunlight SL entering the “on” addressable segment 126 may remain unrotated by the twisted nematic cell 124. Therefore, the P-polarized sunlight SL passes through the reflective polarizer 122b and may radiantly heat the display device 110b in the content area.

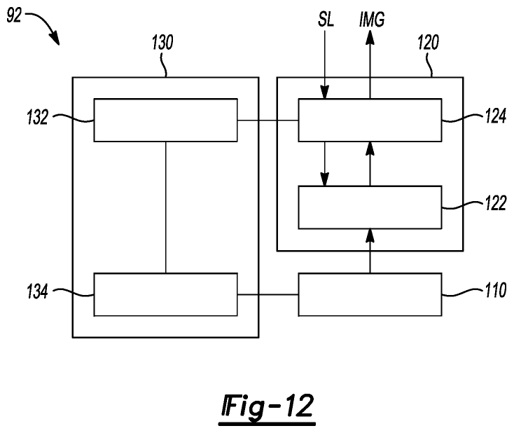

FIG. 12 illustrates a schematic block diagram of an example implementation of the driver circuit 130 and the liquid crystal cell 120 in accordance with one or more embodiments of the head-up display system 92. The driver circuit 130 generally comprises a liquid crystal cell controller 132 and a display controller 134. The liquid crystal cell 120 generally comprises the twisted nematic cell 124 and a reflective polarizer 122. The reflective polarizer 122 may be representative of the reflective polarizer 122a and/or the reflective polarizer 122b.

The liquid crystal cell controller 132 may be in electrical communication with the twisted nematic cell 124 and the display controller 134. The liquid crystal cell controller 132 is generally operational to control the individual addressable segments of the twisted nematic cell 124. The liquid crystal cell controller 132 may coordinate with the display controller 134 to control the addressable segments of the twisted nematic cell 124 to switch the polarization of the active image segments having visible content. The liquid crystal cell controller 132 may control the addressable segments corresponding to the blank image segments based upon the mode of the head-up display system 92. For example, in the normal mode the liquid crystal cell controller 132 may control the addressable segments of the twisted nematic cell 124 the same with the first duty cycle so that all of the image segments are treated the same. In a secondary normal mode, the liquid crystal cell controller 132 may control the addressable segments of the twisted nematic cell 124 corresponding to the blank image segments to set the polarization of the sunlight SL to be reflected by the reflective polarizer 122. In the sunglasses mode, the liquid crystal cell controller 132 may control the addressable segments of the twisted nematic cell 124 the same with the second duty cycle so that all of the image segments are treated the same. In the secondary polarized sunglasses mode, the liquid crystal cell controller 132 may control the addressable segments of the twisted nematic cell 124 corresponding to the blank image segments to set the polarization of the sunlight SL to be reflected by the reflective polarizer 122.

The display controller 134 may be implemented as a video display driver. The display controller 134 may be in electrical communication with the display device 110 and the liquid crystal cell controller 132. The display controller 134 is generally operational to present the images to the display device 110 at the frame rate in all modes. The display controller 134 may also inform the liquid crystal cell controller of which image segments of the images contain visible content. The information may include an indication of a current display mode comprising one or more of an all on mode, the normal mode, the secondary normal mode, an alternative mode, a lane keep assist (LKA) mode, a second LKA mode, a navigation mode, the sunglasses mode and/or the secondary sunglasses mode.

The locally-switched twisted nematic cell 124 in the picture generation unit 100 may operate in one or more of the different modes. In some embodiments of the head-up display system 92, the modes may be selected by the user 94. In other embodiments, a detection method may be used to detect when the user 94 is wearing sunglasses and conclude that the sunglasses are the polarized sunglasses 96.

When used in a windshield-reflecting head-up display system 92, the sunlight SL received by the optical setup 140 may result in heating of the display device 110. As a result of the windshield inclination, the P-component (vertically polarized) of the sunlight energy is generally larger than the S-component (horizontally polarized), in a ratio of approximately 1.75:1. Due to the ratio, blocking the P-component of the sunlight energy may result in a more effective cooling of the display device 110 than blocking the S-component. By dividing the twisted nematic cell 124 into several addressable segments (and thereby allowing local switching), the addressable segments overlapping with or corresponding to areas of no content on the display device 110 may remain in the S-polarization state thus attenuating the sunlight SL intrusion and reducing solar heating of the display device 110.

The above-described approaches may be combined with further sun radiation mitigation strategies. For example, the display device 110 may be placed in an area that is expected to seldom receive direct sunlight, such as embedded deeply within a dashboard and pointing upward toward the dashboard. Furthermore, an intermediate mirror may be used, which may reduce the thermal load to the display device 110. Additionally, infrared absorbent material may be placed at a location toward which the display device 110 faces (e.g., in the optical setup 140). Other modifications, adaptations, and variants may be implemented to meet the design criteria of a particular application.

According to certain embodiments, the head-up display system 92 may include a picture generation unit 100/100a/100b. The head-up display system 92 may also include a liquid crystal cell 124/124a/124b disposed in front of the display device 110 in a picture display direction. The head-up display system 92 may further include a driver circuit 130 configured to drive the liquid crystal cell 120 at a switching frequency greater than a switching frequency of the frame rate of the display device 110.

In various embodiments, the driver circuit 130 may be configured to provide both a vertical polarization state and a horizontal polarization state of the optical signal IMG exiting the liquid crystal cell 120 in a single picture frame period of the picture generation unit 100. The driver circuit 130 may be configured to alter a duty cycle of the addressable segments in the liquid crystal cell 120 based on which of the multiple modes is currently active.

Certain embodiments may relate to a method. The method may be configured to operate in accordance with the various system embodiments described above. The method generally includes, displaying a sequence of images using the picture generation unit 100. The images may include the entire visible content of the head-up display system 92, including graphics, texts, and the like.

The method may further include driving a liquid crystal cell 120 disposed in front of the display device 110 in the picture display direction. The driving may be performed at a switching frequency greater than frame rate of the optical signal IMG. The switching frequency of the liquid crystal cell 120 generally prevents visible interference flicker in the optical signal IMG.

The driving may include providing both a vertical polarization state of and a horizontal polarization state of the optical image IMG in a single picture frame period of the picture generation unit 100. The method may further include altering a duty cycle of the liquid crystal cell 120 based on an active mode of the head-up display system 92. The method generally includes determining whether to use the polarized sunglasses mode or the secondary sunglasses mode. The alteration of the duty cycle may be dependent on whether polarized sunglasses mode or the secondary sunglasses mode is active.

The method may be implemented by a computer processor. For example, a non-transitory computer-readable medium may be encoded with instructions that, when executed in hardware, perform a process. The process generally includes displaying an image using a display device 110. The process may drive the liquid crystal cell 120 disposed in front of the display device 110 in the picture display direction. The driving may be performed at a switching frequency greater than a frame rate of the display device 110.

Certain embodiments are directed toward a new twisted nematic cell configuration that may reduce the heating of the head-up display system 92. More generally, certain embodiments generally relate to any liquid crystal cell configuration, of which twisted nematic (TN), vertically aligned (VA), in-plane switching (IPS) are examples. Any other liquid crystal (LC) modes that change the polarization angle, for example changes the polarization by 90 degrees may also be implemented. Heating of the head-up display system 92 may occur due to the sunlight SL intrusion through the twisted nematic cell 124 to the display device 110. By dividing the nematic cell 124 into several segments and overlapping the segments with areas of no content on the display device 110, the heating of the display device 110 may be reduced, as the areas of no content on the display device 110 may still be protected from the sunlight SL intrusion.

The foregoing detailed description and the drawings are supportive and descriptive of the disclosure, but the scope of the disclosure is defined solely by the claims. As will be appreciated by those of ordinary skill in the art, various alternative designs and embodiments may exist for practicing the disclosure.

1. A head-up display system comprising:
a display device configured to generate a plurality of images at a frame rate, wherein each of the plurality of images includes a plurality of image segments with an initial polarization;
a liquid crystal cell disposed between the display device and a user of the head-up display system, wherein the liquid crystal cell includes a plurality of addressable segments that are aligned with the plurality of image segments, and are individually controllable to selectively adjust the initial polarization of the plurality of image segments between two different polarizations; and
a driver circuit in communication with the display device and the liquid crystal cell, wherein the driver circuit is configured to control the plurality of addressable segments to pass each of the plurality of image segments that has visible content to the user with the initial polarization switched between the two different polarizations at a frequency greater than the frame rate of the plurality of images, and attenuate sunlight that is incident on the display device at each of the plurality of image segments that has blank content.

2. The head-up display system according to claim 1, wherein the liquid crystal cell includes a twisted nematic cell and a reflective polarizer, and the reflective polarizer is disposed between the twisted nematic cell and the display device.

3. The head-up display system according to claim 2, wherein the reflective polarizer is configured to block the sunlight with one of the two different polarizations.

4. The head-up display system according to claim 1, wherein the driver circuit is further configured to control the frequency of the liquid crystal cell to prevent visible interference flicker with the display device.

5. The head-up display system according to claim 1, wherein the two different polarizations of the plurality of images are a vertical polarization and a horizontal polarization.

6. The head-up display system according to claim 5, wherein the driver circuit is further configured to operate with the liquid crystal cell in a normal mode and a polarized sunglasses mode.

7. The head-up display system according to claim 6, wherein the normal mode provides the visible content with the vertical polarization and with the horizontal polarization for similar durations, and the polarized sunglasses mode provides the visible content with the vertical polarization more often than with the horizontal polarization.

8. A head-up display system comprising:
a display device configured to generate a plurality of images at a frame rate and with an initial polarization;
a liquid crystal cell disposed between the display device and a user of the head-up display system, wherein the liquid crystal cell is controllable to selectively adjust the initial polarization of the plurality of images between two different polarizations; and
a driver circuit in communication with the display device and the liquid crystal cell, wherein the driver circuit is configured to control the liquid crystal cell to pass the plurality of images to the user with the initial polarization switched between the two different polarizations at a frequency greater than the frame rate of the plurality of images.

9. The head-up display system according to claim 8, wherein the driver circuit is further configured to control the frequency of the liquid crystal cell to prevent visible interference flicker with the display device.

10. The head-up display system according to claim 8, wherein the two different polarizations of the plurality of images are a vertical polarization and a horizontal polarization.

11. The head-up display system according to claim 10, wherein the driver circuit is further configured to control the frequency of the liquid crystal cell at a first duty cycle in a normal mode and at a second duty cycle in a polarized sunglasses mode, and the first duty cycle is different than the second duty cycle.

12. The head-up display system according to claim 11, wherein the second duty cycle in the polarized sunglasses mode provides the plurality of images with the vertical polarization more often than with the horizontal polarization.

13. The head-up display system according to claim 8, wherein the liquid crystal cell is further configured to attenuate the sunlight incident on the display device while controlled to switch the initial polarization of the plurality of images to one of the two different polarizations.

14. The head-up display system according to claim 8, wherein the liquid crystal cell comprises a twisted nematic liquid crystal cell, a Pi-cell, a vertical alignment liquid crystal cell, or a ferroelectric liquid crystal cell.

15. A head-up display system comprising:
a display device configured to generate a plurality of images, wherein each of the plurality of images includes a plurality of image segments with an initial polarization;
a liquid crystal cell disposed between the display device and a user of the head-up display system, wherein the liquid crystal cell includes a plurality of addressable segments that are aligned with the plurality of image segments and are individually controllable to selectively adjust the initial polarization of the plurality of image segments between two different polarizations; and
a driver circuit in communication with the display device and the liquid crystal cell, wherein the driver circuit is configured to control the plurality of addressable segments to pass each of the plurality of image segments that has visible content to the user, and attenuate sunlight that is incident on the display device at each of the plurality of image segments that has blank content.

16. The head-up display system according to claim 15, wherein the liquid crystal cell comprises a twisted nematic cell and a reflective polarizer, and the reflective polarizer is disposed between the twisted nematic cell and the display device.

17. The head-up display system according to claim 16, wherein the reflective polarizer is configured to reflect the sunlight that has one of the two different polarizations.

18. The head-up display system according to claim 16, wherein the reflective polarizer has a fixed polarization.

19. The head-up display system according to claim 15, wherein the driver circuit is further configured to control the plurality of addressable segments to switch the initial polarization of the plurality of image segments between the two different polarizations at a frequency greater than a frame rate of the plurality of images.

20. The head-up display system according to claim 15, further comprising a windshield configured to attenuate the sunlight with a non-vertical polarization prior to the sunlight reaching the liquid crystal cell.
